(19) United States
(12) Patent Application Publication
(10) Pub. No.: US 2026/0309600 A1
(43) Pub. Date: Oct. 8, 2026

(54) DEVICE AND METHOD FOR TESTING TRAILING-EDGE DELAMINATION IN COMPOSITE GAS TURBINE ENGINE BLADES

(71) Applicant: Northwestern Polytechnical University, Xi’an (CN)

(72) Inventors: Chao Zhang, Xi’an (CN); Zhenqiang Zhao, Xi’an (CN); Yang Bai, Xi’an (CN); Jiahui Gu, Xi’an (CN); Wulin Si, Xi’an (CN)

(21) Appl. No.: 19/457,645

(22) Filed: Jan. 23, 2026

(30) Foreign Application Priority Data
Feb. 11, 2025 (CN) 202510148196.7

(51) Int. Cl. G01N 3/30

(52) U.S. Cl. CPC G01N 3/30; G01N 2203/001; G01N 2203/0096; G01N 2203/021; G01N 2203/0218; G01N 2203/0647

(57) ABSTRACT

Disclosed are a device and a method for testing trailing-edge delamination in composite gas turbine engine blades. The device includes a foreign object impact launching subsystem, a typical blade component test rig, and a high-speed camera monitoring subsystem, where the foreign object impact launching subsystem is configured to launch bird projectiles; the typical blade component test rig is configured to fix a typical blade component, such that the typical blade component is subjected to impact by the bird projectiles; and the high-speed camera monitoring subsystem is configured to monitor a bird projectile impact process and record bird projectile impact test data. The present application achieves the control and adjustment of bird slicing angle, bird strike height, and sliced bird mass by designing an adjustable tooling and a detachable typical blade component fixture on the typical blade component test rig.

### CROSS-REFERENCE TO RELATED APPLICATIONS

This application claims priority to Chinese Patent Application No. 202510148196.7, filed on Feb. 11, 2025, which is hereby incorporated by reference in its entirety.

### TECHNICAL FIELD

The present application belongs to the technical field of foreign object impact on composite gas turbine engine blades, and specifically relates to a device and a method for testing trailing-edge delamination in a typical composite engine blade component.

### BACKGROUND

During aircraft operation, gas turbine engine blades rotate at a high speed. Ingestion of foreign objects into a gas turbine engine may result in collisions between the foreign objects and the gas turbine engine blades, thereby causing damage or fracture of the gas turbine engine blades and potentially leading to catastrophic accidents. Such damage may be classified as soft-body impact damage or hard-body impact damage according to a type of impacting object. When the foreign objects are materials having relatively low hardness, such as birds or ice, the impact is referred to as a soft-body impact.

Composite fan blades have been widely applied in new-generation gas turbine engines due to higher specific strength and specific modulus relative to metal blades. After being subjected to soft-body impacts from birds or similar objects, composite fan blades are susceptible to trailing-edge delamination, which significantly reduces blade service life, increases economic costs, and seriously threatens personnel safety and operational reliability of gas turbine engines. To improve bird-impact resistance and delamination resistance of composite fan blades, selection of composite blade materials and optimization of ply configuration and structural design are required. To achieve the above objectives, a high-speed soft-bird projectile impact test method for a typical blade component is required to be designed, wherein the test method is capable of producing single-sided trailing-edge delamination, thereby enabling comparative verification of impact resistance performance corresponding to different material selections.

One solution in the conventional technology addresses the problem in current engine fan blade bird-strike studies by combining an air cannon and a wedge-headed Hopkinson bar, where the dynamic deformation of the bird and the blade deformation are coupled, making the bird-strike load history unable to be accurately measured. However, this method cannot further achieve clamping and impact of a typical blade component after completing the bird-strike. Another solution transfers the impulse from the projectile fired by the air cannon to the test blade by using an impulse conversion device as an intermediary. The bird-strike simulation is completed through blade impact testing with the bird specimen, without directly firing the test blade from the barrel, improving the convenience and accuracy of bird-impact testing methods for blades. However, in this method, the blade is restricted within a slide rail, making it impossible to perform bird-strikes at specific angles or orientations. In a third solution, a bird-strike test fixture for gas turbine engine blades allows the angle of the blade facing the bird to be changed simply by adjusting the circumferential installation angle of the mounting base relative to the lower support, without the need to disassemble and reinstall the test blade, thereby enabling quick and simple operation. However, this fixture cannot adjust the impact height when the projectile path is fixed, making it impossible to perform impacts at different blade heights.

Overall, the above technical solutions and devices cannot simultaneously satisfy the requirements for bird-strike testing of blades or typical blade components, namely achieving adjustable clamping of the test component and high-precision monitoring and control of parameters such as impact velocity, bird height, and sliced bird mass. These parameters have a direct effect on the preset location and size of trailing-edge delamination. Therefore, no technical solution currently exists for performing trailing-edge delamination of typical blade components under soft-body impact.

### SUMMARY

An objective of the present application is to solve the problem in the prior art that the impact height, impact angle, and sliced bird mass cannot be adjusted simultaneously, and that test schemes are limited by equipment, making accurate control of impact conditions difficult. To achieve the objective, a device and a method for testing trailing-edge delamination of a typical composite engine blade component are proposed.

The present application adopts the following technical solution. According to a first aspect, a device for testing trailing-edge delamination of a typical composite engine blade component includes a foreign object impact launching subsystem, a typical blade component test rig, and a high-speed camera monitoring subsystem. The typical blade component test rig includes a tooling, a typical blade component fixture, and a floor-mounted adjustable slide rail; the tooling is connected to the floor-mounted adjustable slide rail; the typical blade component fixture is connected to the tooling;
the foreign object impact launching subsystem is configured to launch bird projectiles;
the typical blade component test rig is configured to fix a typical blade component, such that the typical blade component is subjected to impact by the bird projectiles;
the high-speed camera monitoring subsystem is configured to monitor a bird projectile impact process and record bird projectile impact test data;
the tooling is configured to fix the typical blade component fixture and position the typical blade component, ensuring stability of the typical blade component during the impact process;
the typical blade component fixture is configured to fix the typical blade component and adjust a height and an angle of the typical blade component;

The adjustable slide rail is an embedded lifting slide rail, configured to allow the tooling to be horizontally fixed on the floor or elevated above the floor and translated, thereby adjusting a height and an angle of the typical blade component to achieve adjustment of an impact height and an impact angle.

The present application has the following beneficial effects:

The present application, by designing a tooling and a typical blade component fixture in a multi-degree-of-freedom adjustable typical blade component test rig, enables simultaneous adjustment of an impact height and an impact angle in a trailing-edge delamination test of composite gas turbine engine blades, further enables adjustment of sliced bird mass based on adjustment of the impact height and the impact angle, and thereby achieves precise regulation of key test parameters to satisfy requirements of various operating conditions.

In a preferred embodiment, the tooling includes a trapezoidal base and a base plate located above the trapezoidal base; the floor-mounted adjustable slide rail is arranged below the trapezoidal base; an elongated through slot and a positioning hole are provided on the base plate;
the elongated through slot is configured to fix the base plate to the trapezoidal base;
the positioning hole is configured to fix the typical blade component fixture and to provide a preset impact angle.

In a preferred embodiment, the typical blade component fixture is a single-side clamping structure, including a front cover plate and a rear base plate, where the front cover plate and the rear base plate are both L-shaped;
two columns of threaded holes are provided on the front cover plate in a vertical direction, where an upper threaded hole and a lower threaded hole in a right column of the threaded holes are configured to provide right-side clamping force of a clamping region; a row of slotted holes is provided at a bottom portion of the front cover plate in a horizontal direction, configured to fix the front cover plate to the tooling;
two rows of threaded holes are provided on the rear base plate in a vertical direction, where a left column of the threaded holes is an embedded slotted hole, configured to connect with the front cover plate, to fix a typical blade component, and to provide left-side clamping force of a clamping region; and three rows of threaded holes are provided at a bottom portion of the rear base plate in a horizontal direction, configured to connect the tooling at fixed positions.

In a preferred embodiment, the foreign object impact launching subsystem includes a barrel, a compressed gas tank, and a projectile outlet;
the barrel is arranged outside the typical blade component test rig, one end of the barrel is a loading port, where the loading port is connected to the compressed gas tank, the other end of the barrel is the projectile outlet, and the projectile outlet is provided with a multi-stage projectile separation device; a projectile holder is arranged inside the barrel; and an inflation valve is provided on the compressed gas tank.

In a preferred embodiment, the high-speed camera monitoring subsystem includes six high-speed cameras arranged around the typical blade component test rig, a plurality of light sources, and a computer data acquisition unit; where the computer data acquisition unit is electrically connected to the plurality of high-speed cameras and the plurality of light sources;
the six high-speed cameras are as follows:
a front high-speed camera, configured to capture the process of bird projectile impact and to detect whether the bird projectile exits the barrel abnormally;
a side high-speed camera, configured to capture a flight path of the bird projectile, having a narrow and elongated field of view, with a height consistent with the bird projectile, where an impact velocity is measured according to pixel analysis;
a top-suspended high-speed camera, configured to capture the process of the bird projectile being cut by the typical blade component fixture;
two rear high-speed cameras, configured to calculate out-of-plane deformation fields of the typical blade component during the impact process, where placement positions of the two rear high-speed cameras are symmetrical with respect to a centerline of the typical blade component;
a rear-side high-speed camera, configured to capture a height position of the bird projectile impacting the typical blade component fixture, where a placement angle of the rear-side high-speed camera is perpendicular to a surface of the typical blade component fixture.

The above preferred embodiments have the following beneficial effects:

1. The row of slotted holes at the bottom portion of the front cover plate is connected to the tooling for fixation and is adjustable in position, providing installation tolerance, which can be used to clamp typical blade components of different thicknesses.

2. The embedded slotted hole on the rear base plate is configured to limit the insertion depth of the typical blade component, thereby enabling precise adjustment of key test parameters.

3. The use of a plurality of high-speed cameras for monitoring enables accurate measurement of foreign object impact velocity, bird strike height, sliced bird mass, and out-of-plane deformation fields. The arrangement of a plurality of light sources provides illumination on the front, back, and top of the typical blade component, facilitating clear monitoring of parameters for subsequent data analysis.

According to a second aspect, a method for testing trailing-edge delamination of a typical composite engine blade component includes the following steps:
S1. assembling a trailing-edge delamination test device for the typical composite engine blade component, and performing pre-test preparation and adjustment;
S2. calibrating a measurement device, where the measurement device includes a plurality of high-speed cameras;
S3. performing a delamination test of the typical blade component using the adjusted trailing-edge delamination test device for the typical composite engine blade component, and recording test data using the calibrated measurement device;
S4. processing the recorded test data during the test to complete the trailing-edge delamination test of the typical composite blade component with controllable damage location and damage area.

In a preferred embodiment, the step S1 specifically includes the following substeps:
connecting and sealing a loading port with a compressed gas tank, and installing a multi-stage projectile separation device at a projectile outlet;
installing a trapezoidal base onto a floor-mounted adjustable slide rail, and installing a typical blade component fixture onto a base plate and fixing the typical blade component fixture to the trapezoidal base;
aligning a central axis of a barrel muzzle in a horizontal direction and a central axis of the barrel muzzle in a vertical direction using laser positioning, and moving the trapezoidal base along a horizontal slide rail, such that a centerline of the trapezoidal base is aligned with the central axis of the barrel muzzle in the horizontal direction, to complete horizontal projectile exit position calibration; and simultaneously completing projectile exit height calibration on the typical blade component fixture according to the central axis in the vertical direction.

In a preferred embodiment, calibrating the measurement device in the step S2 includes field-of-view adjustment and image calibration.

In a preferred embodiment, the step S3 specifically includes the following substeps:
adjusting a position of the base and a clamping height of the typical blade component according to a preset sliced bird mass and a bird strike height;
turning on light sources and setting high-speed cameras and a computer data acquisition unit to a trigger-waiting state;
installing protective and energy absorption modules on a high-speed camera monitoring subsystem, marking feature points on a bird projectile, placing the bird projectile on a projectile holder, and loading the bird projectile into a barrel;
opening an inflation valve, closing the inflation valve when a pressure gauge indicates a specified pressure;
starting a foreign object impact launching subsystem and triggering the high-speed cameras and the computer data acquisition unit to begin monitoring a bird projectile impact process;
after the impact, saving first two frames of image data recorded by the high-speed cameras of the bird projectile impacting the typical blade component, sequentially removing the protective and energy absorption modules, cleaning a multi-stage projectile separation device, and removing a projectile holder and the typical blade component;
recording delamination conditions of the typical blade component, analyzing the impact process of the typical blade component, recording delamination data of the typical blade component, photographing test conditions, and shutting down the test device.

In a preferred embodiment, processing the recorded test data during the test in the step S4 includes calculation of bird projectile impact velocity, calculation of bird strike height, and calculation of sliced bird mass;
the calculation of bird projectile impact velocity includes the following steps:
performing pixel calibration on a high-speed camera, specifically including placing a scale ruler within a field of view and capturing an image to obtain a captured image;
according to the captured image, where an actual length L corresponds to pixel values X₁ and X₂, each pixel difference represents actual distance α;

$$α = L / ( {X}_{2} - {X}_{1} ) ;$$

according to displacement coordinate information of a marked point in two different time frames during the test from camera image, which are (x₁, y₁) and (x₂, y₂) respectively, a calculation formula of bird projectile impact velocity V is obtained as:

$$v = \frac{( {x}_{2} - {x}_{1} ) * α}{f * Δ T} ;$$

where ΔT represents a difference between the two time frames, and f represents a sampling frame rate of the high-speed camera;
the calculation of bird strike height is specifically as follows: observing a leading-edge line of a bird projectile that first contacts a typical blade component fixture from a speed-measurement high-speed camera; observing an intersection point between the leading-edge line of the bird projectile and a scale line on the typical blade component fixture within a field of view of a rear-side high-speed camera, and adding a distance from an upper edge of the typical blade component to the scale line, to obtain a distance between a bird projectile impact point and an upper edge of a simulated component, where the obtained distance is the bird strike height;
the calculation of sliced bird mass is specifically as follows: after acceleration and projectile separation of a bird projectile from a barrel, the bird projectile directly impacts a vertical column surface of a typical blade component fixture and is cut by an edge line, where one portion flies obliquely along an original velocity direction and finally impacts a typical blade component, and another portion flies laterally along a direction perpendicular to a velocity direction; according to images captured by a top high-speed camera, a percentage of a cut bird projectile relative to an original bird projectile is calculated, to obtain the sliced bird mass.

### BRIEF DESCRIPTION OF THE DRAWINGS

FIG. 1 is a schematic diagram of a structure of a device for testing trailing-edge delamination of a typical composite engine blade component provided in Embodiment 1 of the present application.

FIG. 2 is a schematic diagram of a structure of a tooling provided in Embodiment 1 of the present application.

FIG. 3 is a schematic diagram of a structure of a typical blade component fixture provided in Embodiment 1 of the present application.

FIG. 4 is a schematic top view of the typical blade component fixture provided in Embodiment 1 of the present application.

FIG. 5 is a schematic diagram of a front cover plate and a rear base plate of the typical blade component fixture provided in Embodiment 1 of the present application.

FIG. 6 is a flowchart of a method for testing trailing-edge delamination of a typical composite engine blade component provided in Embodiment 2 of the present application.

FIG. 7 is a schematic diagram illustrating a principle of bird projectile impact velocity calculation provided in Embodiment 2 of the present application.

FIG. 8 is a schematic diagram illustrating a principle of bird strike height calculation provided in Embodiment 2 of the present application.

FIG. 9 is a schematic diagram illustrating a principle of sliced bird mass calculation provided in Embodiment 2 of the present application.

Reference numerals: 100. foreign object impact launching subsystem; 200. typical blade component test rig; 300. high-speed camera monitoring subsystem;
1. tooling; 2. adjustable slide rail; 3. typical blade component fixture; 4. inflation valve; 5. compressed gas tank; 6. loading port; 7. barrel; 8. projectile holder; 9. multi-stage projectile separation device; 10. light source; 11. high-speed camera; 12. base plate; 13. trapezoidal base; 14. front cover plate; 15. rear base plate; 16. bird projectile; 17. typical blade component; 18. projectile outlet; 19. lifting slide rail; 20. elongated through slot; 21. positioning hole; 22. threaded hole; 23. embedded slotted hole; 24. computer data acquisition unit; and 25. slotted hole.

### DESCRIPTION OF EMBODIMENTS

Exemplary embodiments of the present application are described in detail below with reference to the accompanying drawings. It should be understood that the embodiments shown and described in the accompanying drawings are merely exemplary and are intended to illustrate the principles and spirit of the present application, rather than to limit the scope of the present application.

Before describing specific embodiments of the present application, to make the technical solutions of the present application clearer and more complete, definitions of key terms appearing in the present application are first provided as follows:

Soft-body impact: During aircraft operation, composite gas turbine engine fan blades rotate at a high rotational speed and may ingest foreign objects, resulting in impacts between the composite gas turbine engine fan blades and the foreign objects and causing damage to the composite gas turbine engine fan blades. When the foreign object is formed of a material having relatively low hardness, such as a bird, the impact is referred to as a “soft-body impact”.

Air cannon: An air cannon using gas in a compressed state as a launching medium, driving a test projectile to accelerate within a barrel, and enabling the projectile to obtain a required high experimental velocity at a muzzle.

Bird projectile: A projectile made of materials such as gelatin and used to simulate a real bird body.

Trailing-edge position: A free end of a blade located away from a clamping position and rotation direction.

Typical blade component: An equivalent flat plate component used to simulate an engine blade.

Bird slicing and sliced bird mass: A bird body ingested from an engine inlet is sliced by a leading edge of an engine blade at a predetermined angle, and the bird body, after being sliced, is separated into two parts and continues to impact a surface of a typical blade component and other portions, which is referred to as a “bird slicing condition”. A percentage of an overall volume of a bird body that, after being sliced, impacts a surface of a typical blade component is referred to as a sliced bird mass.

Bird strike height: A vertical distance between a tooling position impacted by a bird projectile during slicing and an upper edge position of the typical blade component.

### Embodiment 1

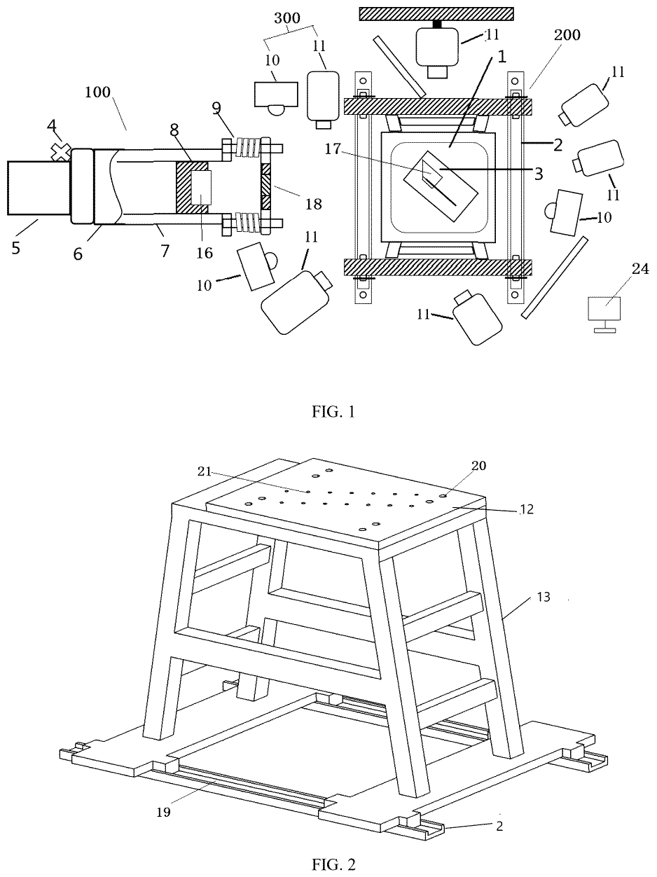

As shown in FIG. 1, a device for testing trailing-edge delamination of a typical composite engine blade component includes a foreign object impact launching subsystem 100, namely an air cannon, a typical blade component test rig 200, and a high-speed camera monitoring subsystem 300;
the foreign object impact launching subsystem 100 is configured to launch bird projectiles 16;
the typical blade component test rig 200 is configured to fix a typical blade component 17, such that the typical blade component 17 is subjected to impact by the bird projectiles;
the high-speed camera monitoring subsystem 300 is configured to monitor a bird projectile impact process and record bird projectile impact test data;
a tooling 1 is configured to fix a typical blade component fixture 3 and position the typical blade component 17, ensuring stability of the typical blade component 17 during the impact process;
the typical blade component fixture 3 is configured to fix the typical blade component 17 and adjust a height and an angle of the typical blade component 17;
an adjustable slide rail 2 is an embedded lifting slide rail 19, configured to allow the tooling 1 to be horizontally fixed on the floor or elevated above the floor and translated, thereby adjusting a height and an angle of the typical blade component 17 to achieve adjustment of an impact height and an impact angle.

In this embodiment, the typical blade component test rig 200 includes the tooling 1, the typical blade component fixture 3, and a floor-mounted adjustable slide rail 2; the tooling 1 is connected to the floor-mounted adjustable slide rail 2; the typical blade component fixture 3 is connected to the tooling 1; and the adjustable slide rail 2 is the embedded lifting slide rail 19.

In this embodiment, as shown in FIG. 2, the tooling 1 includes a trapezoidal base 13 and a base plate 12 positioned above the trapezoidal base 13; the trapezoidal base 13 is integrally formed by welding, and the trapezoidal base 13 is connected to the floor-mounted adjustable slide rail 2, which can be fixed horizontally on the floor or translated after being elevated above the floor; the base plate 12 is provided with an elongated through slot 20 and a positioning hole 21;
the elongated through slot 20 is configured to fix the base plate 12 to the trapezoidal base 13;
the positioning holes 21 are configured to fix the typical blade component fixture 3 and to provide a preset impact angle.

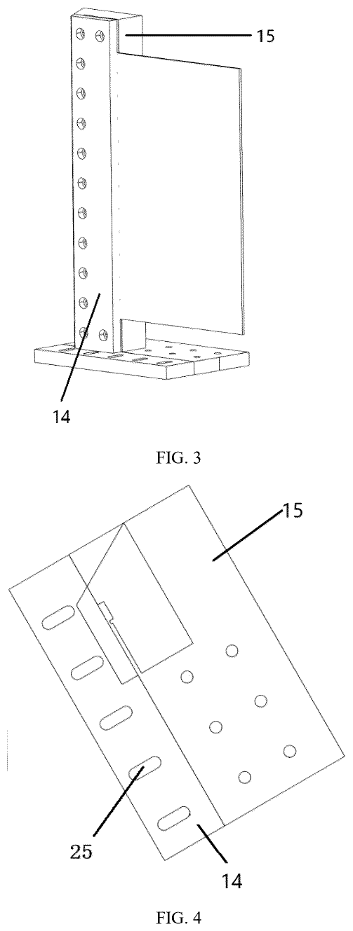

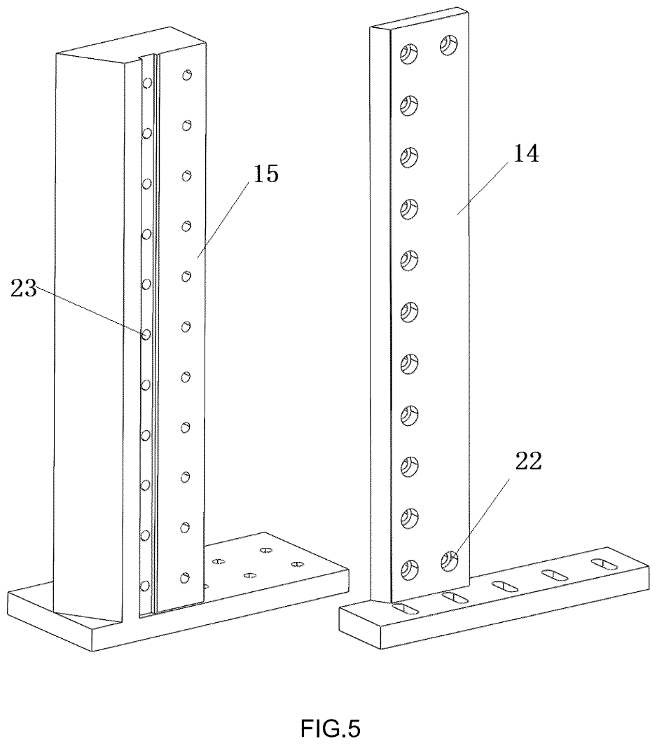

In this embodiment, as shown in FIGS. 3, 4, and 5, the typical blade component fixture 3 is a single-sided clamping type, and includes a front cover plate 14 and a rear base plate 15, and the front cover plate 14 and the rear base plate 15 each have an “L” shape;

Two columns of threaded holes 22 are provided on the front cover plate 14 in a vertical direction, where an upper threaded hole 22 and a lower threaded hole 22 in a right column of the threaded holes are configured to provide right-side clamping force of a clamping region; a row of slotted holes is provided at a bottom portion of the front cover plate 14 in a horizontal direction, which is connected to the tooling 1 for fixation and is position-adjustable, thereby providing installation tolerance and enabling clamping of the typical blade components 17 of different thicknesses.

Two rows of threaded holes 22 are provided on the rear base plate 15 in a vertical direction, where a left column of the threaded holes is an embedded slotted hole 23, configured to connect with the front cover plate 14, to fix the typical blade component 17 and to provide left-side clamping force of a clamping region, and the embedded slotted hole 23 is configured to limit the insertion depth of the typical blade component 17. Three rows of threaded holes 22 are provided at a bottom portion of the rear base plate 15 in a horizontal direction, configured to connect the tooling 1 at fixed positions.

In this embodiment, the foreign object impact launching subsystem 100 includes a barrel 7, a compressed gas tank 5, and a projectile outlet 18.

The barrel 7 is disposed outside the typical blade component test rig 200, one end of the barrel 7 is a loading port 6 configured for loading a bird projectile, the bird projectile is a soft-body bird projectile, and the loading port 6 is connected to the compressed gas tank 5 for inflating and releasing high-pressure gas; the other end of the barrel 7 is a projectile outlet 18, which serves as the exit position of the soft-body bird projectile, the projectile outlet 18 is provided with a multi-stage projectile separation device 9 configured to separate the bird projectile and the projectile holder 8 immediately before exiting the barrel, thereby preventing the projectile holder 8 from acting as an unintended non-impact object and striking the blade together with the projectile, which would make the results difficult to decouple and quantify; the barrel 7 is internally provided with the projectile holder 8, and the projectile holder 8 is a specially 3D-printed holder configured to carry the soft-body bird projectile; and the compressed gas tank 5 is provided with an inflation valve 4.

In this embodiment, the high-speed camera monitoring subsystem 300 includes six high-speed cameras 11 arranged around the typical blade component test rig 200, a plurality of light sources 10, and a computer data acquisition unit 24; where the computer data acquisition unit 24 is electrically connected to the plurality of high-speed cameras 11 and the plurality of light sources 10;
the six high-speed cameras 11 are as follows:
a front high-speed camera, configured to capture the process of bird projectile impact and to detect whether the bird projectile exits the barrel abnormally;
a side high-speed camera, configured to capture a flight path of the bird projectile, having a narrow and elongated field of view, with a height consistent with the bird projectile, where an impact velocity is measured according to pixel analysis;
a top-suspended high-speed camera, configured to capture the process of the bird projectile being cut by the typical blade component fixture 3;
two rear high-speed cameras, configured to calculate out-of-plane deformation fields of the typical blade component 17 during the impact process, where placement positions of the two rear high-speed cameras are symmetrical with respect to a centerline of the typical blade component 17, and the positions and fields of view are adjusted to ensure acquisition of the displacement field data of the entire typical blade component 17;
a rear-side high-speed camera, configured to capture a height position of the bird projectile impacting the typical blade component fixture 3, where a placement angle of the rear-side high-speed camera is perpendicular to a surface of the typical blade component fixture 3. The plurality of high-speed cameras 11 are used for monitoring, and are configured to measure information including the foreign object impact velocity, bird strike height, sliced bird mass, and out-of-plane deformation field. The arrangement of a plurality of light sources provides illumination on the front, back, and top of the typical blade component 17, facilitating clear monitoring of parameters for subsequent data analysis.

### Embodiment 2

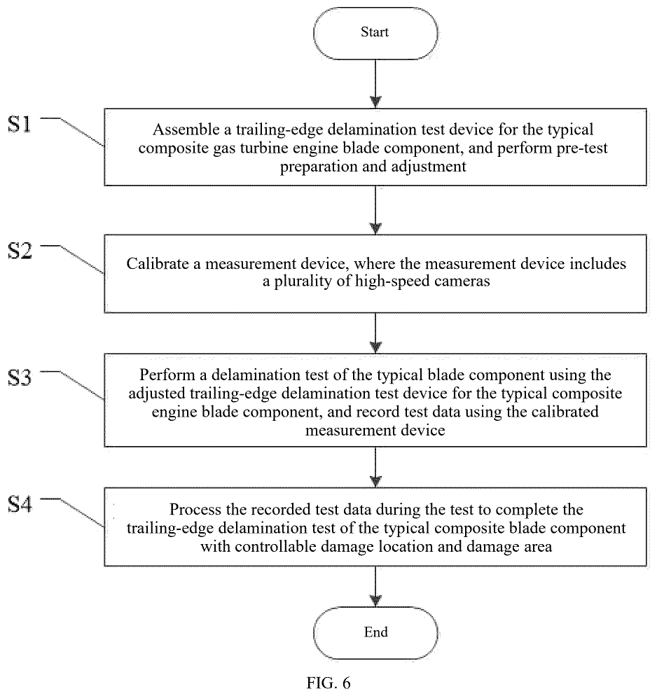

Based on Embodiment 1, this embodiment provides a method for testing trailing-edge delamination of a typical composite engine blade component, as shown in FIG. 6, and the method includes the following steps:
S1. assembling a trailing-edge delamination test device for the typical composite engine blade component, and performing pre-test preparation and adjustment;
S2. calibrating the high-speed camera monitoring subsystem 300;
S3. performing a delamination test of the typical blade component using the adjusted trailing-edge delamination test device for the typical composite engine blade component, and recording test data using the calibrated high-speed camera monitoring subsystem 300;
S4. processing the recorded test data during the test to complete the trailing-edge delamination test of the typical composite blade component with controllable damage location and damage area.

In this embodiment, the step S1 specifically includes the following substeps:
connecting and sealing the loading port 6 with the compressed gas tank 5, and installing the multi-stage projectile separation device 9 at the projectile outlet 18;
installing the trapezoidal base 13 onto a floor-mounted adjustable slide rail 2, and installing the typical blade component fixture 3 onto the base plate 12 and fixing the typical blade component fixture to the trapezoidal base 13;
aligning a central axis of a barrel muzzle in a horizontal direction and a central axis of the barrel muzzle in a vertical direction using laser positioning, and moving the trapezoidal base 13 along a horizontal slide rail, such that a centerline of the trapezoidal base 13 is aligned with the central axis of the barrel muzzle in the horizontal direction to complete horizontal projectile exit position calibration for subsequent adjustment of different sliced bird masses; aligning, on the typical blade component fixture 3, the central axis in the vertical direction with the vertical central axis of the barrel to complete projectile exit height calibration for subsequent adjustment of bird strike height; finally, arranging the plurality of high-speed cameras 11 at a plurality of positions, with bulletproof glass used for protection.

In this embodiment, calibrating the high-speed camera monitoring subsystem 300 in the step S2 includes field-of-view adjustment and image calibration. The field-of-view adjustment varies according to the placement of different cameras. In this embodiment, a total of six high-speed cameras 11 are involved: a front high-speed camera, configured to capture the process of bird projectile impact and to detect whether the bird projectile exits the barrel abnormally; a side high-speed camera, configured to capture a flight path of the bird projectile, having a narrow and elongated field of view, with a height consistent with the bird projectile, where an impact velocity is measured according to pixel analysis; a top-suspended high-speed camera, configured to capture the process of the bird projectile being cut by the fixture, positioned such that, in a top-down view, the vertical edges of the fixture are as fully visible as possible, thereby facilitating subsequent calculation of sliced bird mass based on image analysis; two rear high-speed cameras, configured to calculate out-of-plane deformation fields of the typical blade component 17 during the impact process, where placement positions of the two rear high-speed cameras are symmetrical with respect to a centerline of the typical blade component 17, and the positions and fields of view are adjusted to ensure acquisition of the displacement field data of the entire typical blade component 17; and a rear-side high-speed camera, configured to capture the height at which the bird projectile impacts the fixture, where the camera is oriented as close to perpendicular to the fixture surface as possible, thereby enabling higher-precision identification of the impact height scale.

In this embodiment, the step S3 specifically includes the following substeps:
S31. adjusting the position of the base and the clamping height of the typical blade component 17 according to a preset sliced bird mass and a bird strike height;
S32. turning on the light sources 10 and setting the high-speed cameras 11 and the computer data acquisition unit to a trigger-waiting state;
S33. installing protective and energy absorption modules on the high-speed camera monitoring subsystem 300, marking feature points on the bird projectile, placing the bird projectile on the projectile holder 8, and loading the bird projectile into the barrel 7;
S34. opening the inflation valve 4, closing the inflation valve 4 when a pressure gauge indicates a specified pressure;
S35. starting the foreign object impact launching subsystem 100 and triggering the high-speed cameras 11 and the computer data acquisition unit to begin monitoring a bird projectile impact process;
S36. after the impact, saving first two frames of image data recorded by the high-speed cameras 11 of the bird projectile impacting the typical blade component 17, sequentially removing the protective and energy absorption modules, cleaning the multi-stage projectile separation device 9, and removing the projectile holder 8 and the typical blade component 17;
S37. recording delamination conditions of the typical blade component 17, analyzing the impact process of the typical blade component 17, recording delamination data of the typical blade component 17, photographing test conditions, and shutting down the test device.

In this embodiment, processing the recorded test data during the test in the step S4 includes calculation of bird projectile impact velocity, calculation of bird strike height, and calculation of sliced bird mass;
the calculation of bird projectile impact velocity includes the following steps:
performing pixel calibration on the high-speed camera 11, specifically including placing a scale ruler within a field of view and capturing an image to obtain a captured image;

as shown in FIG. 7, according to the captured image, where an actual length L corresponds to pixel values X₁ and X₂, each pixel difference represents actual distance α:

$$α = L / ( {X}_{2} - {X}_{1} ) ;$$

according to displacement coordinate information of a marked point in two different time frames during the test from camera image, which are (x₁, y₁) and a (x₂, y₂) respectively, a calculation formula of bird projectile impact velocity v is obtained as:

$$v = \frac{( {x}_{2} - {x}_{1} ) * α}{f * Δ T} ;$$

where ΔT represents a difference between the two time frames, and f represents a sampling frame rate of the high-speed camera.

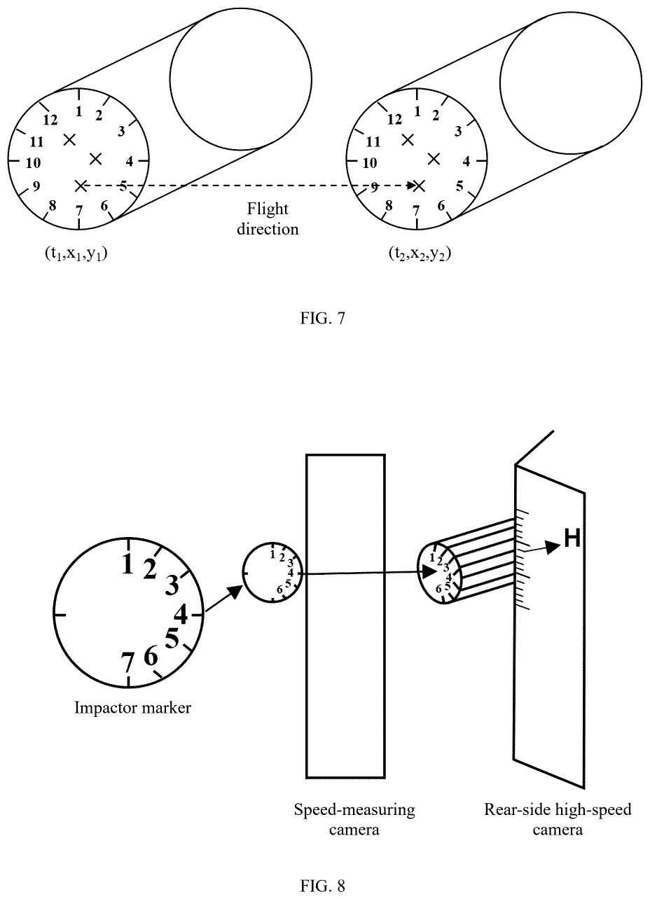

The calculation of bird strike height requires combining the side high-speed camera and the rear-side high-speed camera, as shown in FIG. 8. Specifically, the front edge line of the bird projectile that first contacts the fixture of the typical blade component 3 is observed from the side high-speed camera, corresponding to scale 4 in FIG. 8. Then, the intersection point between the extended line of scale 4 and the scale line on the fixture of the typical blade component 3 is observed within the field of view of the rear-side high-speed camera. By further adding the distance from the upper edge of the typical blade component 17 to the scale line, the distance from the bird projectile impact point to the upper edge of the simulated component is obtained, which corresponds to the bird strike height.

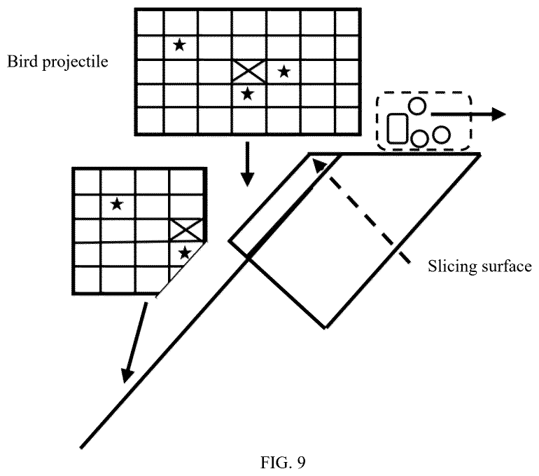

The calculation of sliced bird mass, as shown in FIG. 9, is specifically as follows: after acceleration and projectile separation of the bird projectile from the barrel 7, the bird projectile directly impacts the vertical column surface of the typical blade component fixture 3 and is cut by an edge line, where one portion flies obliquely along an original velocity direction and finally impacts the typical blade component 17, and another portion flies laterally along a direction perpendicular to a velocity direction. According to images captured by the top high-speed camera, the percentage of the cut bird projectile relative to the original bird projectile is calculated, to obtain the sliced bird mass.

It will be appreciated by those of ordinary skill in the art that the embodiments described herein are intended to help readers understand the principles of the present application, and it should be understood that the protection scope of the present application is not limited to such specific descriptions and embodiments. Those of ordinary skill in the art may make various other specific modifications and combinations based on the technical inspirations disclosed in the present application without departing from the essence of the present application, and these modifications and combinations are still within the protection scope of the present application.

What is claimed is:

1. A device for testing trailing-edge delamination of a typical composite engine blade component, comprising a foreign object impact launching subsystem, a typical blade component test rig, and a high-speed camera monitoring subsystem, wherein the typical blade component test rig comprises a tooling, a typical blade component fixture, and a floor-mounted adjustable slide rail; the tooling is connected to the floor-mounted adjustable slide rail; the typical blade component fixture is connected to the tooling;
the foreign object impact launching subsystem is configured to launch bird projectiles;
the typical blade component test rig is configured to fix a typical blade component, such that the typical blade component is subjected to impact by the bird projectiles;
the high-speed camera monitoring subsystem is configured to monitor a bird projectile impact process and record bird projectile impact test data;
the tooling is configured to fix the typical blade component fixture and position the typical blade component, ensuring stability of the typical blade component during the impact process;
the typical blade component fixture is configured to fix the typical blade component and adjust a height and an angle of the typical blade component;
the adjustable slide rail is an embedded lifting slide rail, configured to allow the tooling to be horizontally fixed on the floor or elevated above the floor and translated, thereby adjusting a height and an angle of the typical blade component to achieve adjustment of an impact height and an impact angle;
the typical blade component fixture is a single-side clamping structure and comprises a front cover plate and a rear base plate, and the front cover plate and the rear base plate are both L-shaped;
two columns of threaded holes are provided on the front cover plate in a vertical direction, wherein an upper threaded hole and a lower threaded hole in a right column of the threaded holes are configured to provide right-side clamping force of a clamping region; a row of slotted holes is provided at a bottom portion of the front cover plate in a horizontal direction, configured to fix the front cover plate to the tooling;
two rows of threaded holes are provided on the rear base plate in a vertical direction, wherein a left column of the threaded holes is an embedded slotted hole, configured to connect with the front cover plate, to fix the typical blade component, and to provide left-side clamping force of a clamping region; and three rows of threaded holes are provided at a bottom portion of the rear base plate in a horizontal direction, configured to connect the tooling at fixed positions.

2. The device for testing trailing-edge delamination of the typical composite engine blade component according to claim 1, wherein the tooling comprises a trapezoidal base and a base plate located above the trapezoidal base; the floor-mounted adjustable slide rail is arranged below the trapezoidal base; an elongated through slot and a positioning hole are provided on the base plate;
the elongated through slot is configured to fix the base plate to the trapezoidal base;
the positioning hole is configured to fix the typical blade component fixture and to provide a preset impact angle.

3. The device for testing trailing-edge delamination of the typical composite engine blade component according to claim 1, wherein the foreign object impact launching subsystem comprises a barrel, a compressed gas tank, and a projectile outlet;
the barrel is arranged outside the typical blade component test rig, one end of the barrel is a loading port, wherein the loading port is connected to the compressed gas tank, the other end of the barrel is the projectile outlet, and the projectile outlet is provided with a multi-stage projectile separation device; a projectile holder is arranged inside the barrel; and an inflation valve is provided on the compressed gas tank.

4. The device for testing trailing-edge delamination of the typical composite engine blade component according to claim 1, wherein the high-speed camera monitoring subsystem comprises six high-speed cameras arranged around the typical blade component test rig, a plurality of light sources, and a computer data acquisition unit; wherein the computer data acquisition unit is electrically connected to the plurality of high-speed cameras and the plurality of light sources;
the six high-speed cameras are as follows:
a front high-speed camera, configured to capture the process of bird projectile impact and to detect whether the bird projectile exits the barrel abnormally;
a side high-speed camera, configured to capture a flight path of the bird projectile, having a narrow and elongated field of view, with a height consistent with the bird projectile, wherein an impact velocity is measured according to pixel analysis;
a top-suspended high-speed camera, configured to capture the process of the bird projectile being cut by the typical blade component fixture;
two rear high-speed cameras, configured to calculate out-of-plane deformation fields of the typical blade component during the impact process, wherein placement positions of the two rear high-speed cameras are symmetrical with respect to a centerline of the typical blade component;
a rear-side high-speed camera, configured to capture a height position of the bird projectile impacting the typical blade component fixture, wherein a placement angle of the rear-side high-speed camera is perpendicular to a surface of the typical blade component fixture.

5. A test method based on the device for testing trailing-edge delamination of the typical composite engine blade component according to claim 1, comprising the following steps:
S1. assembling a trailing-edge delamination test device for the typical composite engine blade component, and performing pre-test preparation and adjustment;
S2. calibrating the high-speed camera monitoring subsystem;
S3. performing a delamination test of the typical blade component using the adjusted trailing-edge delamination test device for the typical composite engine blade component, and recording test data using the calibrated high-speed camera monitoring subsystem;
S4. processing the recorded test data during the test to complete the trailing-edge delamination test of the typical composite blade component with controllable damage location and damage area.

6. The test method based on the device for testing trailing-edge delamination of the typical composite engine blade component according to claim 5, wherein the step S1 specifically comprises the following substeps:
connecting and sealing the loading port with the compressed gas tank, and installing the multi-stage projectile separation device at the projectile outlet;
installing the trapezoidal base onto a floor-mounted adjustable slide rail, and installing the typical blade component fixture onto the base plate and fixing the typical blade component fixture to the trapezoidal base;
aligning a central axis of a barrel muzzle in a horizontal direction and a central axis of the barrel muzzle in a vertical direction using laser positioning, and moving the trapezoidal base along a horizontal slide rail, such that a centerline of the trapezoidal base is aligned with the central axis of the barrel muzzle in the horizontal direction, to complete horizontal projectile exit position calibration; and simultaneously completing projectile exit height calibration on the typical blade component fixture according to the central axis in the vertical direction.

7. The test method based on the device for testing trailing-edge delamination of the typical composite engine blade component according to claim 5, wherein calibrating the high-speed camera monitoring subsystem in the step S2 comprises field-of-view adjustment and image calibration.

8. The test method based on the device for testing trailing-edge delamination of the typical composite engine blade component according to claim 5, wherein the step S3 specifically comprises the following substeps:
adjusting a position of the base and a clamping height of the typical blade component according to a preset sliced bird mass and a bird strike height;
turning on the light sources and setting the high-speed cameras and the computer data acquisition unit to a trigger-waiting state;
installing protective and energy absorption modules on the high-speed camera monitoring subsystem, marking feature points on the bird projectile, placing the bird projectile on the projectile holder, and loading the bird projectile into the barrel;
opening the inflation valve, closing the inflation valve when a pressure gauge indicates a specified pressure;
starting the foreign object impact launching subsystem and triggering the high-speed cameras and the computer data acquisition unit to begin monitoring the bird projectile impact process;
after the impact, saving first two frames of image data recorded by the high-speed cameras of the bird projectile impacting the typical blade component, sequentially removing the protective and energy absorption modules, cleaning the multi-stage projectile separation device, and removing the projectile holder and the typical blade component;
recording delamination conditions of the typical blade component, analyzing the impact process of the typical blade component, recording delamination data of the typical blade component, photographing test conditions, and shutting down the test device.

9. The test method based on the device for testing trailing-edge delamination of the typical composite engine blade component according to claim 5, wherein processing the recorded test data during the test in the step S4 comprises calculation of bird projectile impact velocity, calculation of bird strike height, and calculation of sliced bird mass;
the calculation of bird projectile impact velocity comprises the following steps:
performing pixel calibration on the high-speed cameras, specifically comprising placing a scale ruler within a field of view and capturing an image to obtain a captured image;
according to the captured image, wherein an actual length L corresponds to pixel values X₁ and X₂, each pixel difference represents actual distance α:
$$α = L / ( {X}_{2} - {X}_{1} ) ;$$
according to displacement coordinate information of a marked point in two different time frames during the test from camera image, which are (x₁, y₁) and (x₂, y₂), respectively, a calculation formula of bird projectile impact velocity V is obtained as:
$$v = \frac{( {x}_{2} - {x}_{1} ) * α}{f * Δ T} ;$$
wherein ΔT represents a difference between the two time frames, and f represents a sampling frame rate of the high-speed camera;
the calculation of bird strike height is specifically as follows: observing a leading-edge line of the bird projectile that first contacts the typical blade component fixture from a speed-measuring high-speed camera in the high-speed cameras; observing an intersection point between the leading-edge line of the bird projectile and a scale line on the typical blade component fixture within a field of view of the rear-side high-speed camera in the high-speed cameras, and adding a distance from an upper edge of the typical blade component to the scale line, to obtain a distance between a bird projectile impact point and an upper edge of a simulated component, wherein the obtained distance is the bird strike height;
the calculation of sliced bird mass is specifically as follows: after acceleration and projectile separation of the bird projectile from the barrel, the bird projectile directly impacts a vertical column surface of the typical blade component fixture and is cut by an edge line, wherein one portion flies obliquely along an original velocity direction and finally impacts the typical blade component, and another portion flies laterally along a direction perpendicular to a velocity direction; according to images captured by the top high-speed camera in the high-speed cameras, a percentage of a cut bird projectile relative to an original bird projectile is calculated, to obtain the sliced bird mass.
